(19) United States
(12) Patent Application Publication
(10) Pub. No.: US 2015/0308666 A1
(43) Pub. Date: Oct. 29, 2015

(54) Outdoor Light with Dual Installation Options

(71) Applicant: ARTIKA FOR LIVING INC., Dorval (CA)

(72) Inventor: Raymond JEPSON, ROXBORO (CA)

(21) Appl. No.: 14/699,419

(22) Filed: Apr. 29, 2015

Related U.S. Application Data
(60) Provisional application No. 61/985,753, filed on Apr. 29, 2014.

(51) Int. Cl. F21V 17/12; F21V 21/14; F21V 21/08; F21V 21/116; F21S 6/00; F21S 8/08

(52) U.S. Cl. CPC F21V 17/12; F21S 6/005; F21S 8/08; F21V 21/0824; F21V 21/116; F21V 21/14; F21W 2131/109

(57) ABSTRACT

An outdoor light comprises a bottom cap configured to allow the light to be either mounted onto a hard surface (e.g. wood, composite, etc.) or anchored into the soil. The bottom cap comprises at least one generally central aperture configured to receive a ground-engaging spike, and at least two peripheral apertures configured to receive fasteners (e.g. screws, bolts, nails, etc.). When the ground-engaging spike is mounted into the central aperture, the light can be anchored into the ground. When fasteners are mounted through the at least two peripheral apertures, the light can be mounted onto a hard surface.

### CROSS-REFERENCE TO RELATED APPLICATIONS

The present patent application claims the benefits of priority of American Provisional Patent Application No. 61/985,753, entitled “Outdoor Light with Dual Installation Options”, and filed at the United States Patent and Trademark Office on Apr. 29, 2014, the content of which is incorporated herein by reference.

### FIELD OF THE INVENTION

The present invention generally relates to lights and lamps and more particularly relates to outdoor ground lights and lamps.

### BACKGROUND OF THE INVENTION

Ground lights are often installed outdoor around houses and cottages to add light during evenings and to add decorative features.

Most ground lights are configured to be installed in the soil and are thus configured for such installation. Consequently, most outdoor lights are ill-suited for installation on decks, docks, platforms and other structures which surface is too hard.

Consequently, there is a need for an outdoor light that mitigates at least some of the shortcomings of prior art outdoor lights.

### SUMMARY OF THE INVENTION

The shortcomings of the prior art are generally mitigated by an outdoor light which is configured to be selectively mounted either in the soil or on a hard surface.

The invention is first directed to a light comprising:
a. a vertically extending light support;
b. a top cap mounted to said vertically extending light support; and
c. a bottom cap having an outer sleeve configured to be removably received into the lower end of the light support, the bottom cap having an opening for securing the light to an adjoining surface.

The invention is also directed to a light comprising:
a. a vertically extending light support;
b. a top light element mounted to said vertically extending light support;
c. the vertically extending light support comprising a lower opening;
d. a longitudinal body member having an upper end configured to receive the vertically extending light support and a lower end, and
e. a bottom cap having an outer sleeve configured to be removably received into the lower end of the longitudinal body member, the bottom cap having an opening for securing the light to an adjoining solid surface.

An outdoor light in accordance with the principles of the present invention generally comprises a removable bottom cap comprising a generally central opening and a plurality of peripheral openings.

The central opening is generally configured to removably receive a ground-engaging spike which is mounted therein when the light is to be installed into the soil.

The peripheral openings are suitable sized and shaped to receive fasteners such as, but not limited to, screws, bolts, and nails, when the light is to be installed on a hard and generally flat surface (e.g. a deck, a dock, a platform, etc.).

By being able to be either anchored into the soil or mounted onto a hard and substantially flat surface, an outdoor light in accordance with the principles of the present invention generally mitigates at least some shortcoming of prior art outdoor ground lights.

The invention is yet further directed to a method to anchor a light as claimed in claim 1, the method comprising the steps of:
a. inserting the top cap to the vertically extending light support;
b. securing the bottom cap onto a hard surface using a fastener; and
c. mounting the light support to the bottom cap.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a perspective exploded view of an embodiment of an outdoor light in accordance with the principles of the present invention.

FIG. 2 is a top perspective view of the bottom cap of the light of FIG. 1.

FIG. 3 is a top view of the bottom cap of the light of FIG. 1.

FIG. 4 is a side view of the bottom cap of the light of FIG. 1.

FIG. 5 is a cross-sectional side view of the bottom cap of the light of FIG. 1, along line B-B of FIG. 3.

FIG. 6 is a top perspective view of the spike of the light of FIG. 1.

FIG. 7 is a side view of the spike of the light of FIG. 1.

FIG. 8 is a top view of the spike of the light of FIG. 1.

FIG. 9 is bottom view of the spike of the light of FIG. 1.

FIG. 10 is a perspective view of the bottom of the light of FIG. 1 during the insertion of the ground-engaging spike in the bottom cap.

FIG. 11 is a perspective view of the bottom of the light of FIG. 1 during the mounting of the fasteners through the bottom cap.

FIG. 12 is a perspective assembled view of the light of FIG. 1.

FIG. 13 is a perspective exploded view of another embodiment of an outdoor light in accordance with the principles of the present invention.

FIG. 14 is a top perspective view of the bottom cap of the light of FIG. 13.

FIG. 15 is a top view of the bottom cap of the light of FIG. 13.

FIG. 16 is a side view of the bottom cap of the light of FIG. 13.

FIG. 17 is a cross-sectional side view of the bottom cap of the light of FIG. 13, along line B-B of FIG. 33.

FIG. 18 is a top perspective view of the spike of the light of FIG. 13.

FIG. 19 is a side view of the spike of the light of FIG. 13.

FIG. 20 is a top view of the spike of the light of FIG. 13.

FIG. 21 is bottom view of the spike of the light of FIG. 13.

FIG. 22 is a perspective view of the bottom of the light of FIG. 13 during the insertion of the ground-engaging spike in the bottom cap.

FIG. 23 is a perspective view of the bottom of the light of FIG. 13 during the mounting of the fasteners through the bottom cap.

FIG. 24 is a perspective assembled view of the light of FIG. 13.

### DETAILED DESCRIPTION OF THE PREFERRED EMBODIMENT

A novel outdoor light will be described hereinafter. Although the invention is described in terms of specific illustrative embodiments, it is to be understood that the embodiments described herein are by way of example only and that the scope of the invention is not intended to be limited thereby.

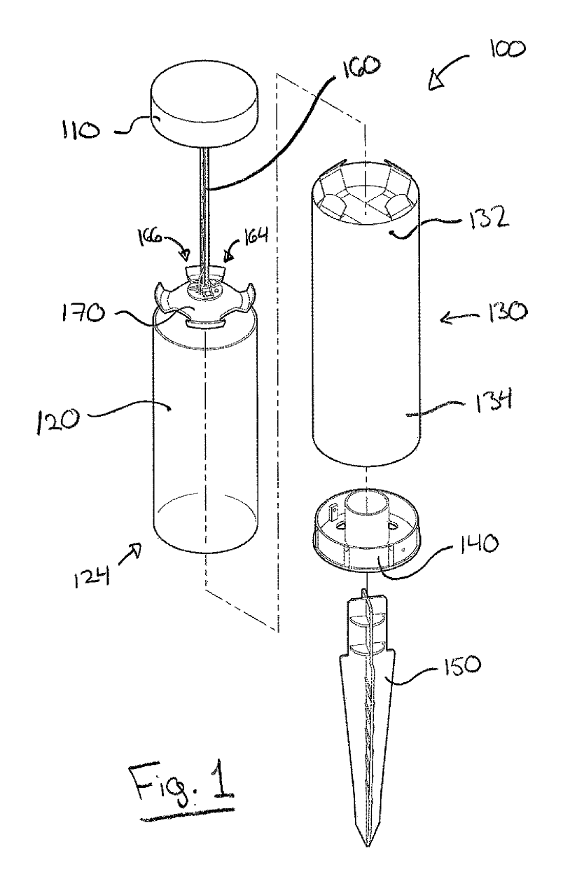

Referring first to FIG. 1, an exploded view of an embodiment of an outdoor light 100 in accordance with the principles of the present invention in shown. In the present embodiment, the light 100 is generally of cylindrical shape. However, in other embodiments, the light 100 could have a different shape.

Going from top to bottom, the light 100 generally comprises a top cap or cover 110 to which is mounted a vertically extending light support 160, a bottom support plate 170 mounted to the lower end 164 of the light support 160, a transparent or translucent cylindrical sleeve 120 configured to receive the top cover 110, the light support 160 and the support plate 170, a main light body 130 which upper end 132 is configured to receive the lower end 124 of the sleeve 120 and the support plate 170, a bottom cap 140 configured to be removably received into the lower end 134 of the main body 130, and an optional ground-engaging spike 150.

The light 100 is shown fully assembled, without the spike 150, in FIG. 12.

In the present embodiment, the light support 160 supports a plurality of upper and lower LED lights 166 which generate the light of the light 100.

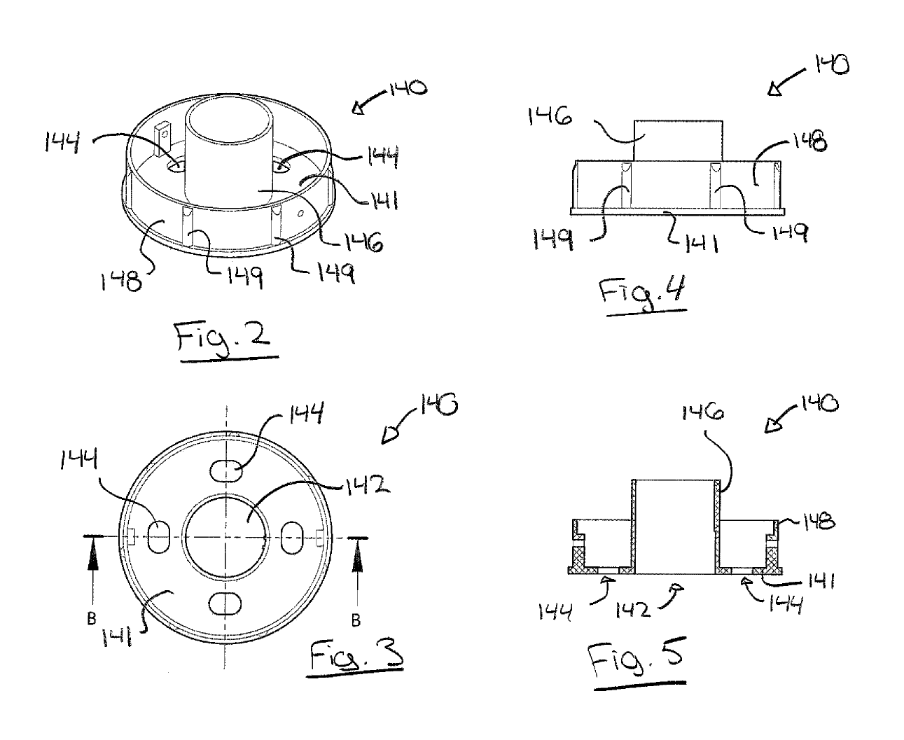

Referring now to FIGS. 2 to 5, the bottom cap 140 of the light 100 will be described in more detail. The bottom cap 140 is configured to allow the light 100 to be either anchored into the soil or mounted onto a substantially flat and hard surface (e.g. a deck, a dock, a platform, etc.).

In the present embodiment, the bottom cap 140 comprises a substantially central opening 142 and a plurality of peripheral openings 144. As best shown in FIG. 3, in the present embodiment, there are four peripheral openings 144 and the peripheral openings 144 are equally disposed about the central opening 142.

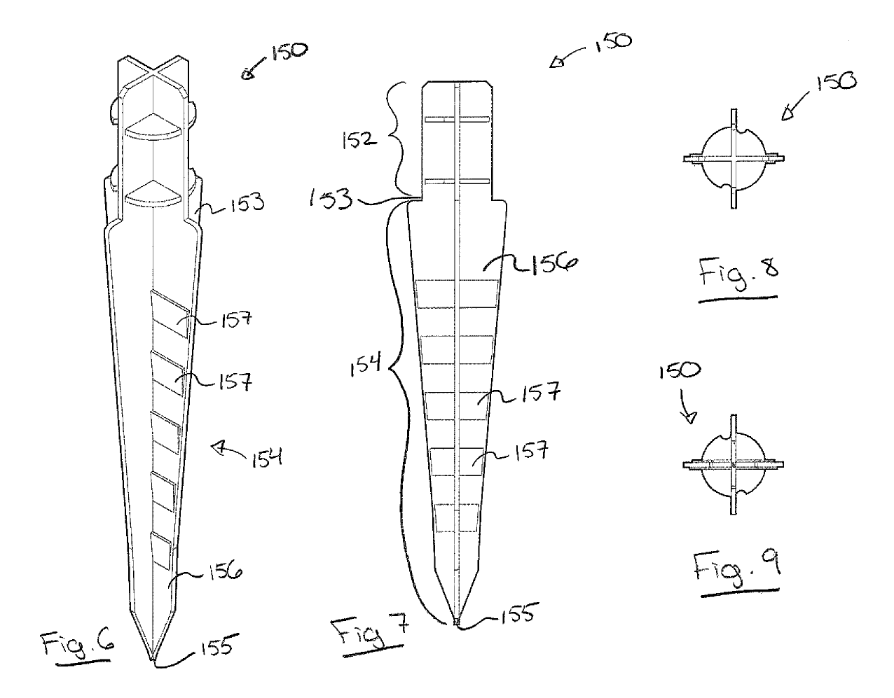

The bottom cap 140 also comprises an inner sleeve 146 extending upwardly from the bottom wall 141 of the bottom cap 140, and an outer sleeve 148 also extending upwardly from the bottom wall 141 of the bottom cap 140. As best shown in FIGS. 2 and 5, the inner sleeve 146 is coextensive with the central opening 142 and is generally configured to removably receive the upper portion 152 of the ground-engaging spike 150 when the spike 150 is used to anchor the light 100 into the soil. For its part, the outer sleeve 148 is generally configured to removably engage the lower end 134 of the main body 130 of the light 100 (see also FIGS. 1, 11 and 12). In that sense, in the present embodiment, the outer sleeve 148 is provided, on its radially outer surface with a plurality of the spaced-apart ribs 149 configured to frictionally engage the inner surface (not shown) of the lower end 134 of the main body 130 when the bottom cap 140 is mounted thereto.

For their part, the peripheral openings 144 are configured to receive fasteners (e.g.

screws, bolts, nails, etc.) therethrough when the light 100 is mounted onto a hard and generally substantially flat surface. In that sense, the peripheral openings 144 are generally suitable sized and shaped for receiving various types of fasteners.

Also, as best shown in FIG. 3, in the present embodiment, the peripheral openings 144 are oblong to allow for minor adjustments when mounting the bottom cap 140 onto a surface.

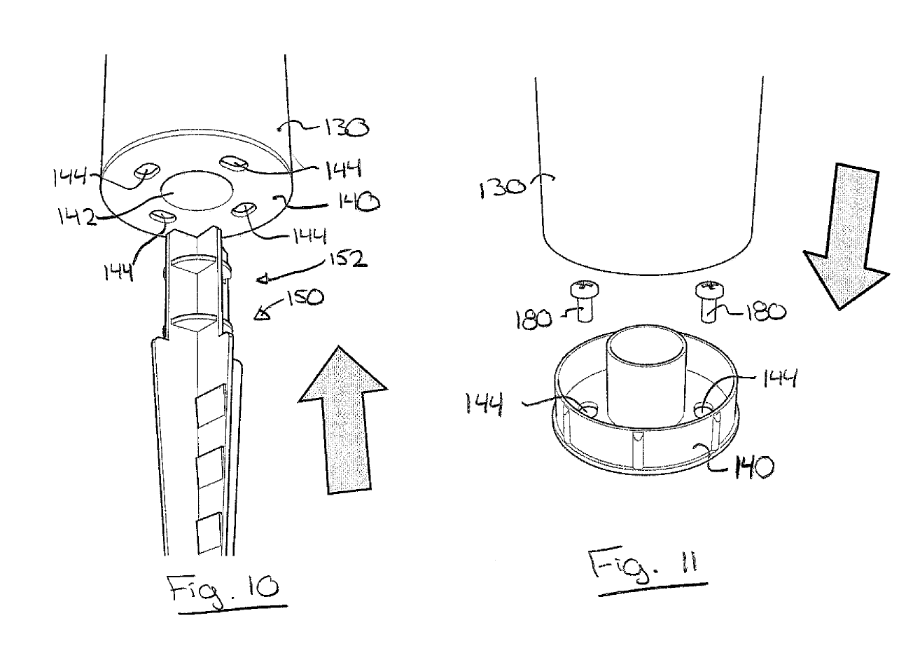

Referring now to FIGS. 6 to 9, the ground-engaging spike 150 is shown in greater details.

The spike 150 generally comprises an upper portion 152 which is configured to be received into the opening 142 and inner sleeve 146 of the bottom cap 140 when the light 100 is to be anchored into the soil, and a lower ground-engaging portion 154 which is configured to be inserted into to the soil and to provide proper anchorage to the light 100.

As best sown in FIG. 7, the upper and lower portions 152 and 154 are separated by a shoulder 153 to the limit the insertion of the upper portion 152 into the opening 144 and sleeve 146.

Referring more particularly to FIGS. 6, 7 and 9, the lower ground-engaging portion 154 generally exhibits a tapering shape which is terminated at its lower end by a point 155. Understandably, the tapered shaped and the point allow for an easier insertion of the lower ground-engaging portion 154 into the soil. In the present embodiment, the lower portion 154 comprises a plurality of blades or members 156 which together exhibit a cross-shaped section (see FIG. 9). As best shown in FIGS. 6 and 7, in the present embodiment, each of the four members 156 comprise a series of barbs 157 to provide proper anchoring of the lower portion 154 into the soil.

As mentioned above, the light 100 can be either anchored into the soil or mounted onto a substantially flat and hard surface.

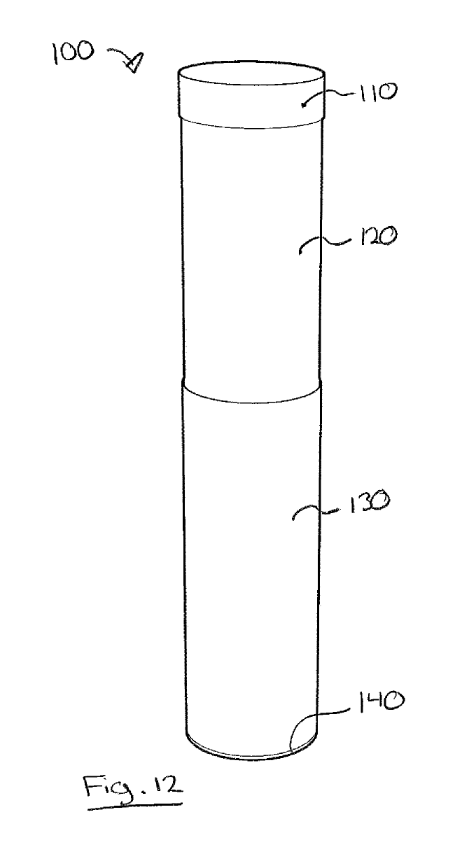

If the light 100 is to be anchored into the soil, the upper portion 152 of the ground-engaging spike 150 is inserted into the opening 142 and inner sleeve 146 until the shoulder 153 abuts on the bottom wall 141 of the bottom cap 140 (see FIG. 10). Then, the lower portion 154 of the ground-engaging spike 150 can be inserted into the soil, generally until the bottom wall 141 of the bottom cap 140 of the light 100 is more or less adjacent with the ground.

If the light 100 is to be mounted onto a hard and substantially flat surface (e.g. a wooden or composite deck, dock or platform), the bottom cap 140 is first temporarily removed from the lower end 134 of the main body 130. Then, the bottom cap 140 is placed flat on the surface where the light 100 is to be installed, and fasteners 180 (e.g.

screws, bolts, nails, etc.) are driven through the peripheral openings 144 (see FIG. 11) until the bottom cap 140 is firmly attached to the surface. Then, the light 100 is lowered onto the bottom cap 140 until the outer sleeve 148 is properly received into the lower end 134 of the main body 130.

Hence, the combination of openings 142 and 144 in the bottom cap 140 of the light 100 allows the light 100 to be either anchored into the soil (with the ground-engaging spike 150) or mounted to a hard and substantially flat surface (with fasteners).

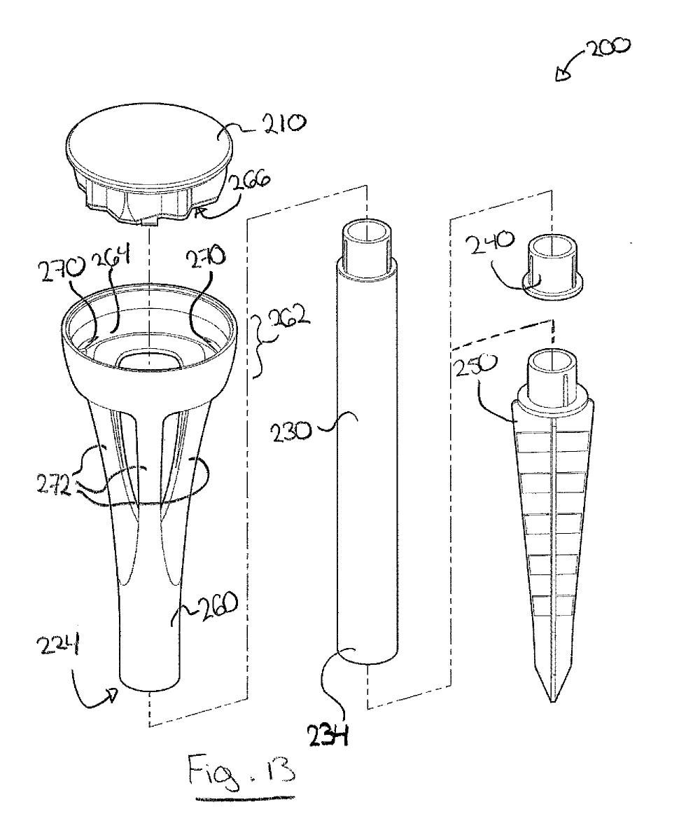

Referring first to FIG. 13, an exploded view of an embodiment of an outdoor light 200 in accordance with the principles of the present invention in shown. In the present embodiment, the light 200 is generally of circular shape. However, in other embodiments, the light 200 could have a different shape.

Going from top to bottom, the light 200 generally comprises a top cap or cover 210 which may comprise a photovoltaic module and LED lights integrated within the top cap to which is mounted a vertically extending light support 260, upper support plates 270 mounted to the lower end 264 of the upper light support portion 262 configured to receive the top cover 210. The light 200 may further comprise a main body 230 which is configured to receive the lower end 224 of the vertically extending light support 260 and the support plate 270, a bottom cap 240 or an optional ground-engaging spike 250 both configured to be removably received into the lower end 234 of the main body 230 or the lower end 224 of the light support 260. The LED lights integrated within the top cap projects downward as to generate light through the tripod 272 of the vertically extending light support 260.

The light 200 is shown fully assembled, without the spike 250, in FIG. 24.

In the present embodiment, the light support 260 supports a plurality of upper LED lights 266 which generate the light of the light 200.

According to the present embodiment, the light may comprise either a bottom cover 240 or a spike 250. As such, the light support 260 and/or the main body 230 are configured to receive any of the bottom cap 240 or the spike 250.

Referring now to FIGS. 14 to 17, the bottom cap 240 of the light 200 will be described in more detail. The bottom cap 240 is configured to allow the light 200 to be either anchored into the soil or mounted onto a substantially flat and hard surface (e.g. a deck, a dock, a platform, etc.).

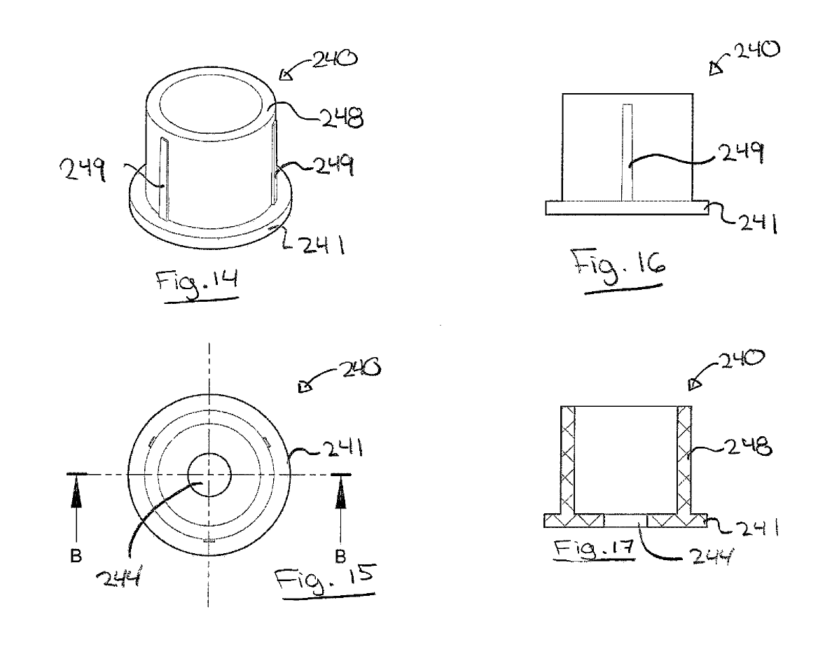

In this embodiment, the bottom cap 240 comprises a substantially central opening 244. As best shown in FIG. 15, in the present embodiment, there is a single central opening 244. Alternatively, the bottom cap 240 could comprise a plurality of peripheral openings (not shown) generally equally disposed about the center of the bottom cap. The bottom cap 240 also comprises an outer sleeve 248 also extending upwardly from the bottom wall 241 of the bottom cap 240. The outer sleeve 248 is generally configured to removably engage the lower end 234 of the main body 230 or the lower end 224 of the light support 260 of the light 200 (see also FIGS. 13, 23 and 24). In that sense, in the present embodiment, the outer sleeve 248 is provided, on its radially outer surface with a plurality of the spaced-apart ribs 249 configured to frictionally engage the inner surface (not shown) of the lower end 234 of the main body 230 or the lower end 224 of the light support 260 when the bottom cap 240 is mounted thereto. For its part, the substantially central opening 244 is configured to receive fasteners (e.g. screws, bolts, nails, etc.) therethrough when the light 100 is mounted onto a hard and generally substantially flat surface. In that sense, the substantially central openings 244 is generally suitable sized and shaped for receiving various types of fasteners.

Referring now to FIGS. 18 to 21, the ground-engaging spike 250 is shown in greater details. The spike 250 generally comprises an upper portion 252, generally similar to the bottom cap 240 which is configured to be received into the bottom portion 234 of the main body portion 230 or the lower end 224 of the light support 260 when the light 200 is to be anchored into the soil, and a lower ground-engaging portion 254 which is configured to be inserted into to the soil and to provide proper anchorage to the light 200.

As best sown in FIG. 19, the upper and lower portions 252 and 254 are separated by a shoulder 253 to limit the insertion of the upper portion 252 into the opening 232 of the lower body portion 234.

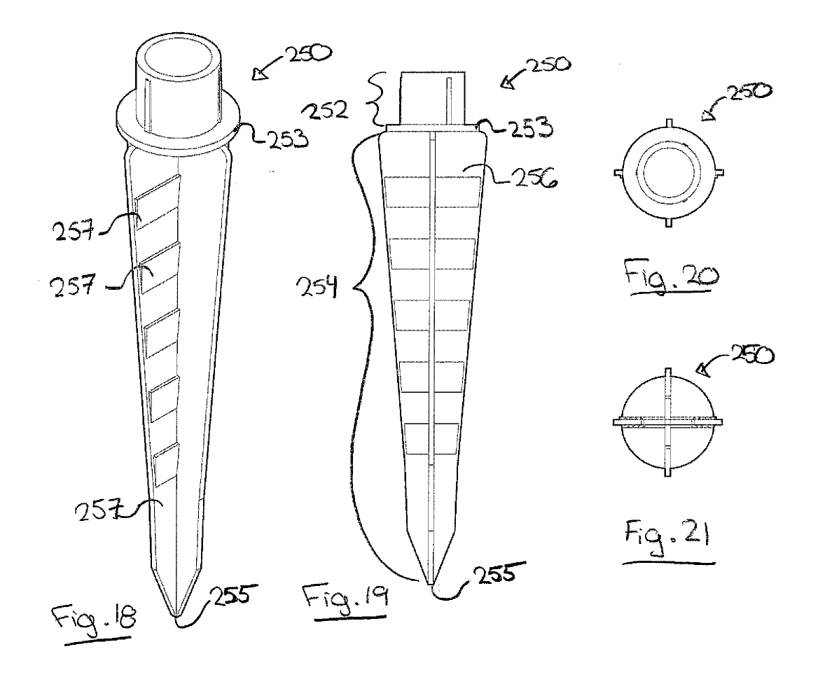

Referring more particularly to FIGS. 18, 19 and 21, the lower ground-engaging portion 254 generally exhibits a tapering shape which may be terminated at its lower end by a point 255. Understandably, the tapered shaped and the point allow for an easier insertion of the lower ground-engaging portion 254 into the soil. In the present embodiment, the lower portion 254 comprises a plurality of blades or members 256 which together exhibit a cross-shaped section (see FIG. 21). As best shown in FIGS. 18 and 19, in the present embodiment, each of the four members 256 comprise a series of barbs 257 to provide proper anchoring of the lower portion 254 into the soil.

As mentioned above, the light 200 can be either anchored into the soil or mounted onto a substantially flat and hard surface.

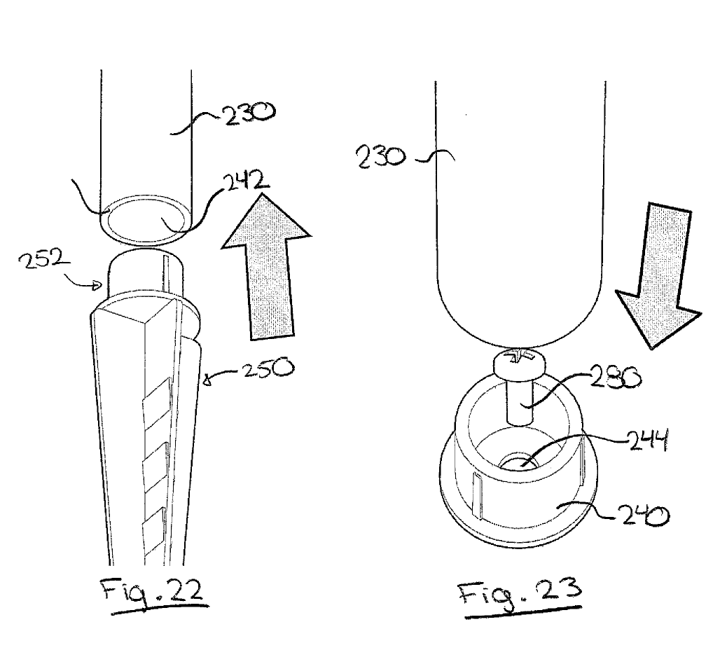

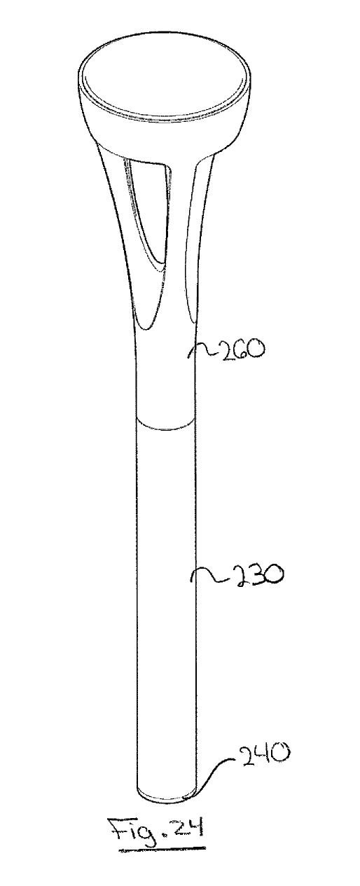

If the light 200 is to be anchored into the soil, the upper portion 252 of the ground-engaging spike 250 is inserted into the opening 232 of the lower body portion 234 until the shoulder 253 abuts on the bottom wall 236 of the main body portion 230 (see FIG. 22). Alternatively, it can be inserted in the lower end 224 of the light support 260. Then, the lower portion 254 of the ground-engaging spike 250 can be inserted into the soil, generally until the lower body portion 234 of the main body portion 230 or the lower end 224 of the light support 260 of the light 200 is more or less adjacent with the ground.

If the light 200 is to be mounted onto a hard and substantially flat surface (e.g. a wooden or composite deck, dock or platform), the bottom cap 240 is first temporarily removed from the lower end 234 of the main body 230 or from the e lower end 224 of the light support 260. Then, the bottom cap 240 is placed flat on the surface where the light 200 is to be installed, and fasteners 280 (e.g. screws, bolts, nails, etc.) are driven through the at least one central opening 244 (see FIG. 23) until the bottom cap 240 is firmly attached to the surface. Then, the light 200 is lowered onto the bottom cap 240 until the outer sleeve 248 is properly received into the lower end 234 of the main body 230 or the lower end 224 of the light support 260.

Hence, the interchangeability of the bottom cap 240 and lower spike 250 of the light 200 allows the light 200 to be either anchored into the soil (with the ground-engaging spike 150) or mounted to a hard and substantially flat surface (with fasteners).

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A light comprising:
a) a vertically extending light support;
b) a top cap mounted to said vertically extending light support; and
c) a bottom cap having an outer sleeve configured to be removably received into the lower end of the light support, the bottom cap having an opening for securing the light to an adjoining surface.

2) A light as claimed in claim 1, wherein the bottom cap further comprises an inner sleeve surrounding an inner opening.

3) A light as claimed in claim 2, the light further comprising a ground-engaging spike having an upper portion configured to be received in the inner sleeve of the bottom cap and a lower ground engaging portion.

4) A light as claimed in claim 3, further comprising a main body interposed between the light support and the bottom cap.

5) A light as claimed in claim 1, wherein the light is secured to the adjoining surface using a fastener inserted through the opening.

6) A light comprising:
a) a vertically extending light support;
b) a top light element mounted to said vertically extending light support;
c) the vertically extending light support comprising a lower opening;
d) a longitudinal body member having an upper end configured to receive the vertically extending light support and a lower end, and
e) a bottom cap having an outer sleeve configured to be removably received into the lower end of the longitudinal body member, the bottom cap having an opening for securing the light to an adjoining solid surface.

7) A light as claimed in claim 6, wherein the bottom cap is a ground-engaging spike having an upper portion configured to be received in the lower end of the longitudinal body member.

8) A light as claimed in claim 6, wherein the light is secured to the adjoining surface using a fastener inserted through the opening.

9) A method to anchor a light as claimed in claim 1, the method comprising the steps of:
a) inserting the top cap to the vertically extending light support;
b) securing the bottom cap onto a hard surface using a fastener; and
c) mounting the light support to the bottom cap.

10) The method as claimed in claim 9, further comprising the step of interposing the main body as described in claim 4 between said light support and said bottom cap.

11) The method as claimed in claim 9, further comprising the steps of removing the light support from the bottom cap and unsecuring the bottom cap from the hard surface.

12) The method as claimed in claim 11, further comprising the step of inserting the ground-engaging spike in soil.

13) The method as claimed in claim 12, further comprising the steps of mounting the light support to the bottom cap and mounting the bottom cap to the ground-engaging spike.
